(19) United States
(12) Patent Application Publication
(10) Pub. No.: US 2001/0041530 A1
(43) Pub. Date: Nov. 15, 2001

(54) Local clean method and local clean processing and treating apparatus

(75) Inventor: Shiro Hara, Ibaraki (JP)

Correspondence Address: PENNIE & EDMONDS LLP, 1667 K STREET NW, SUITE 1000, WASHINGTON, DC, 20006

(73) Assignee: SECRETARY OF AGENCY OF INDUSTRIAL SCIENCE AND TECHNOLOGY, TOKYO 100-8921 (JP)

(21) Appl. No.: 09/751,982

(22) Filed: Dec. 29, 2000

(30) Foreign Application Priority Data
Apr. 18, 2000 (JP) 2000-116567

(51) Int. Cl. B01L 1/04

(52) U.S. Cl. 454/187

(57) ABSTRACT

The present invention provides a method which when a semi-finished product requiring cleanliness is transported between a processing and treating apparatus and a sealed vessel, maintains cleanliness of atmosphere without cleaning outside. When the transported sealed vessel is connected to an air lock means provided on the processing and treating apparatus, space of the air lock means is blocked from the outside such as cleanroom. After that, the air lock space is removed of contaminated external atmosphere. Then, transfer of the semi-finished product is performed between the vessel and the processing and treating apparatus. During this time, the sealed vessel and the processing and treating apparatus is maintained in the cleanliness. This invention localizes and saves the clean plenum needed for clean fabrication, which realizes the reduction of environmental cleanliness in a clean factory. Also, compared with the minienvironment method, this invention saves the footprints of fabrication apparatuses.

### BACKGROUND OF THE INVENTION

This application is based on Patent Application No. 2000-116567 filed Apr. 18, 2000 in Japan, the content of which is incorporated hereinto by reference.

1. Field of the Invention

The present invention relates to a local clean method and local clean processing and treating apparatus for transporting an industrial product such as precision devices like semiconductor devices requiring clean atmosphere during transportation and processing to a processing and treating apparatus for processing and treating the industrial product.

2. Description of the Prior Art

Heretofore, in the production of industrial products requiring cleaning, a method of using a cleanroom has been employed. In the prior art cleanroom, with respect to a boundary of cleanliness class definition of 100 (0.1 μm/ft³), when a higher cleanliness is required, a laminar type (see FIG. 9) has been used, for a very old cleanroom in which a lower cleanliness may be employed, a turbulent type has been used [ref. “ULSI TECHNOLOGY,” eds. C. Y. Chang and S. M. Sze, chap. 1: “Cleanroom Technology” (McGraw-Hill, 1996, ISBN 0-07-063062-3).].

In the production of high technology products requiring a higher cleanliness, it is necessary to improve the cleanliness of the atmosphere of their transportation and processing. The laminar type cleanroom has an advantage that particles generated in the cleanroom are immediately exhausted under the floor to improve the cleanliness. Already from the 1980s, most semiconductor factories have employed the laminar type.

FIG. 9 shows an example of the laminar type cleanroom. In the Figure, numeral 11 denotes a make-up air system, 12 is a recirculation air system, 13 is a flow direction of contaminated air, 14 is a flow direction of return air, 15 is a flow direction of clean air, 16 is an air-supply plenum, 17 is a process level, and 18 is an air-return plenum. The hatched part represents an area requiring a cleanliness of class 1 (0.1 μm/ft³).

However, this type is required to make an additional large air-return plenum 18 for exhaust under the floor, which is the greatest factor of high cost of the cleanroom. Since the main part of the factory is required to have a class 1 (0.1 μm/ft³) cleanliness, the factory construction costs (3-stories structure) and power and filter costs, cleaning cost, apparatus cost, and personal education cost for maintaining the cleanliness are very large amounts.

For such new problems, various methods for locally cleaning only the product atmosphere have been contrived. Typical examples thereof are SMIF (Standard Mechanical InterFace) type for transporting semiconductor wafers and an imperfectly sealed wafer vessel called FOUP (Front Opening Unified Pod) type. These vessels have been considered to maintain the wafer atmosphere clean even without improving the cleanliness of the cleanroom.

FIG. 10 schematically shows a prior art example in which a sealed vessel containing a semi-finished product is transported to a processing and treating apparatus. In FIG. 10, reference numeral 1a denotes a prior art imperfectly sealed vessel not preventing from leaking, 2 is a semi-finished product such as a wafer contained in the imperfectly sealed vessel 1a, 3 is a processing and treating apparatus for processing and treating the transported semi-finished product, 4 is a space formed at the connection part of the imperfectly sealed vessel 1a and the processing and treating apparatus 3 when both parts are connected, and 5 and 6 are shutters. The imperfectly sealed vessel 1a and the processing and treating apparatus 3 are surrounded by contaminated atmosphere.

Step S1 is a state before the imperfectly sealed vessel 1a is connected to the processing and treating apparatus 3, where respective insides of the imperfectly sealed vessel 1a and the processing and treating apparatus 3 are maintained in a clean state. In step S2, the imperfectly sealed vessel 1a is connected to the processing and treating apparatus 3. The space 4 of the connection part of both is contaminated plenum. In step S3, when the respective shutters 5 and 6 of the imperfectly sealed vessel 1a and the processing and treating apparatus 3 are opened to transport the semi-finished product 2 to the processing and treating apparatus 3, contaminated plenum in the space 4 of the connection part of both flows into both of the imperfectly sealed vessel 1a and the processing and treating apparatus 3.

A critical problem occurs also when the imperfectly sealed vessel 1a is transported into the cleanroom and connected to the processing and treating apparatus 3. This is because the cleanliness of the outside of the imperfectly sealed vessel 1a depends on the cleanliness in the cleanroom, when the imperfectly sealed vessel 1a is connected to the processing and treating apparatus 3, the cleanliness of the space 4 necessarily produced at the connection part becomes the same as the cleanroom atmosphere, and the contaminated atmosphere flows into the imperfectly sealed vessel 1a and the processing and treating apparatus 3 through opening the shutters 5,6. Therefore, since in the transportation method of FIG. 10, atmosphere in the processing and treating apparatus 3 is proportional to the cleanliness of the cleanroom, there is a limit in decreasing the production cost of the semi-finished product by reducing the burden of improving the cleanliness of the cleanroom, which is not an effective method.

Actually, in the technology described in the specification of U.S. Pat. No. 4,532,970 which is the first patent of the SMIF system and the specification of the relevant patent U.S. Pat. No. 4,534,389, nothing is described on the space of the connection part between the transportation system and the production apparatus, and importance of contamination of the space is looked over. Further actually, the specification of the first U.S. patent, U.S. Pat. No. 4,534,389 describes as “The various pieces of the system are mechanically interfaced without the need of an air lock by means of unique particle-free dockable door which . . . ”(page 1, column 2, lines 4 to 9). This is because perfectly particle-free transportation is considered to be possible even if the space of the connection part is neglected.

In effect, if the minute space, for example, a space of 1 liter is contaminated atmosphere of class 1,000 (0.1 μm/ft³) in cleanliness class indication, the number of airborne particles existing in the space is as many as 30 pieces. These adhere to the wafer and exert critical effects on the operation of the produced devices and the production yield. Further, by the transportation method of FIG. 10, it is impossible in principle to isolate the wafer from ambient harmful gases.

Further, in the SMIF system, the SMIF vessel and the processing and treating apparatus are assumed to be mechanically connected, and prevention of leakage from the connection part is not entirely made. Specifically, use of an O-ring in the connection part is not defined. This is the same as for the FOUP vessel which is the next-generation vessel. Still further, also for leakage of the vessel itself when capped, no remedy is taken, and particle influx from the outside is not achieved, and the vessel is structured so that when a pressure difference is generated between the inside and outside, particle leak or gas leak is necessarily generated. For the case of the FOUP vessel, a particle filter is provided to reduce the difference between the pressure inside the vessel and that outside it, which is in principle an unprotected specification to gas leak. As described above, in the prior art vessel, there is nothing that can be called perfectly sealed type to particle leak and gas leak. In the present specification, as an exact definition, as an apparent sealed type, a prior art vessel using a vessel covering the entire sample and not taking a leakage remedy is called an imperfectly sealed vessel.

To this problem, a local clean space called a minienvironment is recently developed in which a covered vessel connection port is disposed in front of the processing and treating apparatus. FIG. 11 schematically shows a transportation system using a minienvironment method. In FIG. 11, numeral 7 denotes a minienvironment apparatus attached to the processing and treating apparatus 3.

Before connecting the imperfectly sealed vessel 1a such as the SMIF vessel with the processing and treating apparatus 3 in step S1, insides of the imperfectly sealed vessel 1a and the processing and treating apparatus 3 are maintained in a clean state. In step S2, the imperfectly sealed vessel 1a is encased into the minienvironment apparatus 7. By this operation, inside of the minienvironment apparatus 7 is filled with contaminated atmosphere. In step S3, by purging contaminated atmosphere in the minienvironment apparatus 7, the inside of the minienvironment apparatus 7 is reverted to clean atmosphere. In step S4, the imperfectly sealed vessel 1a is connected to the minienvironment apparatus 7. In step S5, when the space of the connection part is clean atmosphere, the shutters 5 and 6 are opened, for example, to transport the semi-finished product 2 into the processing and treating apparatus 3 via the route shown by the dotted line in the figure. Over this series of operation, insides of the imperfectly sealed vessel 1a and the processing and treating apparatus 3 are maintained in a clean state. In the present specification, those with the same reference numerals denote the same or equivalent components.

The minienvironment method as shown in FIG. 11 provides an effect when transporting the semi-finished product to the processing and treating apparatus 3 in an inexpensive old type cleanroom not high in cleanliness. The above-described minienvironment method also has important problems. One is that, since a minienvironment space is required to cover the entire imperfectly sealed vessel 1a, the processing and treating apparatus is very large in size. An ordinary commercial minienvironment system has dimensions of about height 3 m×width 1.5 m×depth 2 m. From this fact, it has significant disadvantages in terms of installation area and volume. Further, since such a large space is purged with nitrogen (or argon) or with filtered air, it has a problem that time and purge costs for cleaning are increased in proportion to the minienvironment space. Still further, such a large-scale apparatus is very high in cost of the entire apparatus.

Yet further, the minienvironment method is a method developed for removing particles, however, has not a structure of considering harmful gases, not particles, requiring higher-performance leakage resistance. Yet further, in the minienvironment method, normally cleanroom air is sent through a particle filter into the minienvironment apparatus. Therefore, the wafer is not protected from oxygen or harmful chemical gases.

As described above, several local clean methods making up for disadvantages of the cleanroom have ever been developed, however, as described above the prior art is much defective and actually has not substantial advantages that change the concept of the cleanroom itself.

Next, as a patent application example relating to the present invention, there is Japanese Patent Application Laid-open No. 1-258412(1989). In this patent application, transportation means of semi-finished product (that is, wafer transportation apparatus or the like) is provided in a sealed space between a sealed vessel and the processing and treating apparatus. As shown in FIG. 1 of the laid-open publication, there is a problem that by providing the transportation apparatus, the volume size of a chamber handling semi-finished product is several hundreds to several thousands of times larger compared to the size of the sealed vessel or sealed wafer cassette. The technology of this patent application, from the above-described cleanroom concept, belongs to the category of minienvironment. In such a method, from the large volume size, it is necessary to use a large amount of purge gas, and costly nitrogen purge is substantially impossible. Actually in this patent application, it is specified that cleaning of the chamber handling semi-finished product is carried out with air.

Yet further, when a handling mechanism of the semi-finished product is disposed in the chamber handling semi-finished product, it is necessary to develop a handling mechanism having a specific function corresponding to various processing chambers, resulting in a substantially high cost. In addition, as a minienvironment method, there is patent application of Japanese Patent Application Laid-open No. 7-221170 (1995), which is also a method requiring a large space.

As another patent application example, there is patent application of Japanese Patent Application Laid-open No. 10-56050 (1998). In this patent application, based on the present situation that the above SMIF system is commonly used, the disadvantage of weak holding force of the mechanical seal in the SMIF system is improved by a vacuum chuck seal. In this laid-open patent publication, a structure of vacuum evacuation method for the purpose of realizing a vacuum chuck is described. However, this patent application is directed to improvement of the seal holding force, and restrictively claims two points as the scope of claim that a vacuum chuck seal is provided and the structure is a vacuum evacuatable transportation vessel. Further, it is not described in the scope of claim that this device can be utilized in cost reduction of the cleanroom. Therefore, this patent application is an improvement patent application of the SMIF system.

Further, in a patent application of Japanese Patent Application Laid-open No. 7-235580 (1995) by the same inventor et al., a technology of incorporating the shutter of a sealed vessel assuming vacuum evacuation is described. This patent application also shows a specific improvement method of the SMIF system, and does not describe a construction leading to a cost reduction of the cleanroom.

Further, although not relating directly to the present invention, as patent applications using an air lock method, there are Japanese Patent Application Laid-open Nos. 9-167725 (1997), 10-41513 (1998), 10-173127 (1998) and the like. Japanese Patent Application Laid-open No. 9-167725 (1997) is a patent application on static electricity prevention in a method for practically removing particles in an air lock chamber, which differs from the present invention in purpose and effect. The other two patent applications are the methods in which an air lock chamber is provided at the entrance part of a so-called full-line vacuum system (in which a processing and treating apparatus is all physically connected to evacuate the inside in principle, and a semiconductor wafer is moved between them). They are substantially different from the present invention in which a semi-finished product is transported between processing apparatus disposed in separate places. As to the full-line vacuum system, evacuation is difficult in a wet chemical cleaning process that uses liquid solutions, and it is necessary to cover the entire apparatus with a stainless-steel tank, which is impracticably high cost. Therefore, in the past no production apparatus for the purpose of commercialization have been realized.

As described above, in prior art patent applications, patent application is made on partial improvement of clean vessel and an auxiliary device of cleanroom, however, no patent application is made on a technology for wholly innovating the clean production method.

A first problem to be solved by the present invention is to solve the problem, which is a disadvantage of the method using the above imperfectly sealed vessel alone, that the product is exposed to contaminated atmosphere of the cleanroom with generating during product transportation between the processing and treating apparatus and the imperfectly sealed vessel. Since this problem extends to the entire industry of precision products related to electronic devices and cleaning technology, it is expected in view of the spreading effect and effectiveness.

Further, a second problem is to solve the problems of the disadvantage of large size of the apparatus, long purge time, and increased cost by the introduction of the apparatus, which are disadvantages of the method of adding a minienvironment apparatus to the imperfectly sealed vessel. If these problems are solved, it is possible to remarkably reduce the cleanroom cost, and further, to process and treat wafers or the like in the situation not using a cleanroom, and to drastically reduce the cost of all the resulting industrial products. The cleanroom is an important fundamental technology of advanced production technology, and it is expected to be greatly effective to provide a method itself for innovating such an important fundamental technology by solving the first technical problem.

### SUMMARY OF THE INVENTION

As means for solving the above two problems, air lock means is provided between a perfectly sealed semi-finished product transportation apparatus and a processing and treating apparatus connected to the transportation apparatus. This air lock means provides with a vacuum evacuation or gas purge mechanism. With this construction, contaminated atmosphere of cleanroom coming into the air lock space of the air lock means can be removed. Since transportation of products such as wafers is performed after cleaning the atmosphere, the products can be handled without being exposed to contaminated atmosphere from the outside. Further, since the air lock means does not require a volume for covering the entire apparatus, the means can be constructed very small in size, thereby solving the cost problem which is the second problem and innovating the cleaning technology itself. With this local clean method, atmosphere of the semi-finished product can be sufficiently cleaned without improving the cleanliness of the cleanroom.

Further, the present invention provides a local clean method in which when the semi-finished product in the semi-finished product transportation apparatus having a sealing structure is transported into the processing and treating apparatus, the atmosphere in the space is vacuum evacuated or gas purged when the semi-finished product transportation apparatus is connected, after the cleanliness of the air lock space is cleaned to the same as in the processing and treating apparatus, the semi-finished product in the semi-finished product transportation apparatus is transported into the processing and treating chamber through the air lock space.

Still further, the present invention provides a local clean method in which the semi-finished product in the processing and treating apparatus is transported out to the semi-finished product transportation apparatus, the atmosphere in the space is vacuum evacuated or gas purged when the semi-finished product transportation apparatus is connected, after the cleanliness of the air lock space is cleaned to the same as in the processing and treating apparatus, the semi-finished product in the processing and treating apparatus is transported out to the semi-finished product transportation apparatus through the air lock space.

Yet further, the present invention provides a local clean processing and treating apparatus comprising, between the semi-finished product transportation apparatus and the processing and treating apparatus, the air lock means for removing particles and gas molecules of outside air incoming in the air lock space when the semi-finished product transportation apparatus and the processing and treating apparatus are connected. In this case, the air lock mechanism is preferably provided with a vacuum evacuation or gas purge function.

The above and other objects, features and advantages of the present invention will become more apparent from the following description of embodiments thereof taken in conjunction with the accompanying drawings.

### BRIEF DESCRIPTION OF THE DRAWINGS

FIG. 1 is a diagram for explaining transportation of a semi-finished product to the processing and treating apparatus and the principle of the local clean method by the sealed vessel of the present invention;

FIG. 2 is a diagram for comparing the present invention with a prior art;

FIG. 3 is a schematic diagram when the local clean method of the present invention is applied to a turbulent type cleanroom;

FIG. 4 is a diagram showing air lock means of the present invention;

FIG. 5 is a diagram showing a particle removal example in an air lock chamber of the present invention;

FIG. 6 is a diagram showing an oxygen molecule removal example in the air lock chamber of the present invention;

FIG. 7 is a perspective diagram of a vessel to transport the semi-finished product and processing and treating apparatus of the present invention;

FIGS. 8A-8C are diagrams showing an embodiment of the wafer transportation vessel and the air lock means;

FIG. 9 is a diagram for explaining a laminar-flow type cleanroom;

FIG. 10 is a diagram for explaining transportation by a prior art imperfectly sealed vessel; and

FIG. 11 is a diagram for explaining transportation by a prior art imperfectly sealed vessel.

### DESCRIPTION OF THE PREFERRED EMBODIMENT

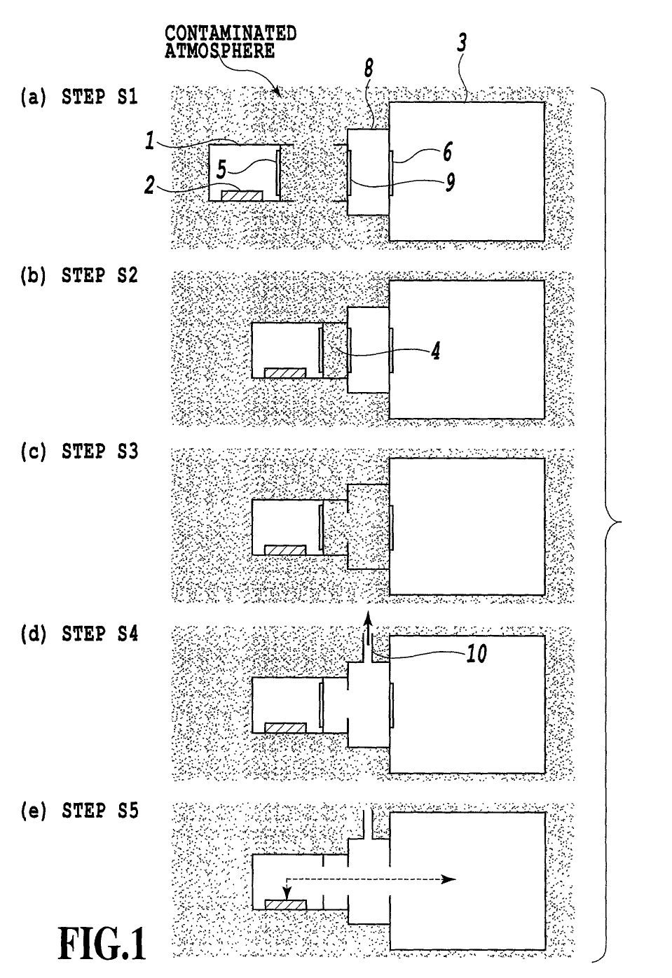

An embodiment of the present invention will be described with reference to FIGS. 1 to 8. FIG. 1 schematically shows a method for transporting a semi-finished product by the air lock means of the present invention. In FIG. 1, numeral 1 denotes a perfectly sealed vessel (hereinafter simply referred to as a sealed vessel) as a perfectly sealed semi-finished product transportation apparatus, 8 is an air lock chamber as the air lock means, 9 is a connection side shutter of the air lock chamber 8, and 10 is a gas evacuation pipe. The sealed vessel 1, the processing and treating apparatus 3 and the air lock chamber 8 are surrounded by contaminated atmosphere.

In step S1, the sealed vessel 1 is transported to the connection side of the air lock chamber 8 with which the processing and treating apparatus is combined. At this moment, insides of the sealed vessel 1 and the processing and treating apparatus 3 are maintained in a clean state. In step S2, the sealed vessel 1 is connected to the air lock chamber 8. The space 4 of the connection part is contaminated with the external atmosphere. In step S3, the connection side shutter 9 is opened. At this moment, the air lock chamber 8 is also contaminated. In step S4, contaminated atmosphere in the air lock chamber 8 is evacuated or purged. The connection part space 4 and inside the air lock chamber 8 are recovered to clean atmosphere. In step S5, the shutter 5 of the sealed vessel 1 and the shutter 6 of the processing and treating apparatus are opened, and the semi-finished product 2 is transported into the processing and treating apparatus 3. In this series of operation steps, in the local clean space connecting such sealed vessel 1—air lock chamber 8—processing and treating apparatus 3, during transportation, contamination from the outside is blocked.

In the embodiment of FIG. 1, the shutter 9 is provided so that the local clean space is always sealed to maintain the cleanliness. However, when cost reduction or transportation time is preferentially considered, the shutter 9 of the air lock chamber 8 may be not provided from the first. If the local clean space produced after connecting the sealed vessel is purged or vacuum evacuated, in principle the same effect can be obtained as the case provided with the shutter.

In this case, the space in the air lock chamber 8 (hereinafter referred to as “air lock space”) provided between the processing and treating apparatus 3 and the sealed vessel 1 for transportation, is exposed to the external atmosphere, when the sealed vessel 1 is not connected to the processing and treating apparatus 3. When the sealed vessel 1 for transportation is connected to the air lock space, the air lock space is blocked from the external atmosphere such as cleanroom, thus forming a sealed space. After that, the air lock space is removed of the contaminated external atmosphere by vacuum evacuation or gas purge. In subsequent step S5, two shutters 5 and 6 between the air lock chamber 8 and the transportation vessel 1 and between the air lock chamber 8 and the processing and treating apparatus 3 are opened. Subsequently, transfer of the semi-finished product 2 is performed between the sealed vessel 1 and the processing and treating apparatus 3. As an alternative procedure, a successive open method is possible in which only one of the two shutters is opened and the semi-finished product is once moved to the air lock space.

A case where the semi-finished product 2 processed and treated in the processing and treating apparatus 3 is transported out to be processed and treated by another processing and treating apparatus will be briefly described. The semi-finished product transportation apparatus for transporting out the semi-finished product is connected directly to the air lock chamber 8 of the processing and treating apparatus 3. Contaminated atmosphere in the air lock chamber 8 produced during the connection is vacuum evacuated or gas purged to make the cleanliness in the air lock chamber 8 same as in the processing and treating apparatus. Then, the shutters 5, 6 and 9 of FIG. 1 are opened to transport out the semi-finished product 2 into the sealed vessel 1, for example, through the route indicated by the dotted line in the figure. After that, the shutters 5, 6 and 9 are closed, and the sealed vessel 1 is moved to the processing and treating apparatus of the subsequent processing and treating process.

Since the air lock space can be designed and fabricated to a very small size, time and cost required for vacuum evacuation and gas purge is considerably reduced. Where the size of the air lock space is V [liter], and flow-in purge gas amount per a unit time is S [liter/min], at the time of V=St (t is time [min], counted from the time to start the gas purge), gas of just the volume is introduced. At this time, when the introduced purge gas has been mixed perfectly in the molecular level with contaminated gas existed at t=0, at the time t of V=St, particles and contaminated gas molecules are reduced to N₀/2, where the contaminant concentration at t=0 is N₀. When perfect mixing in the molecular level is not achieved, evacuation of contaminant becomes faster than N₀/2. This state is represented by formula (1).

$$N < {N}_{0} \cdot {2}^{\cdot \frac{S}{V} t} \qquad ( 1 )$$

According to formula (1), for example, a time t=10V/S [min] for 10 times replacement, a reduction can be achieved to N=N₀/1024, and to N<N₀/10⁶ for 20 times replacement. In this case, consumed purge gas is sufficient by 10V [liter] for 10 times replacement, and by 20V [liter] for 20 times replacement. For the case of evacuation, since contaminated atmosphere is discharged, as is, reduction is made much faster than the above.

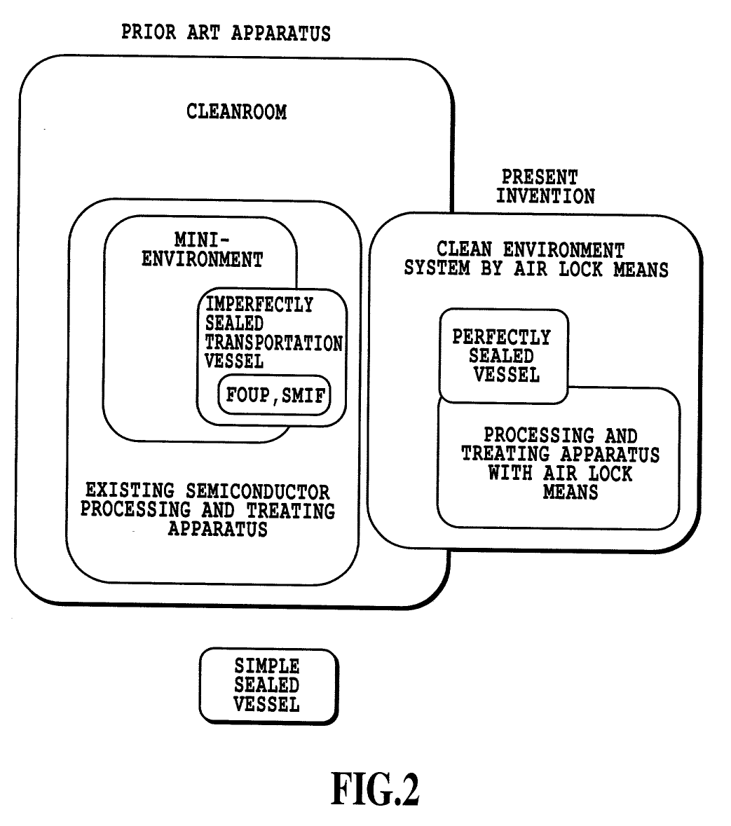

FIG. 2 is a diagram comparing the principle of the sealed vessel transportation method of the present invention with that of the prior art imperfectly (or simply) sealed vessel transportation method. Since in the present invention, the cleanroom is not necessarily required, fundamentally the technology described in all claims is out of the cleanroom concept, and products produced using the present invention and the production method are obviously different from products and production method in the prior art cleanroom.

Further, the minienvironment methods which have heretofore been proposed and commercialized are auxiliary means of the cleanroom, and thus belongs to a different category from the present invention.

Still further, because the above-described SMIF and FOUP systems which have ever been used for wafer transportation in the cleanroom are systems assuming the use in the cleanroom, they are different from the sealed vessel system of the present invention. The imperfectly sealed vessel, the minienvironment method and apparatus thereof are premised on the cleanroom. Since, in the present invention, the assumption of the cleanroom is not necessary, the present invention is a novel method quite different from these prior art methods.

Yet further, when the present invention is used in combination with the cleanroom, even with a low performance cleanroom, the same cleanliness environment can be obtained. For example, when the method of the present invention is employed, even with the turbulent type cleanroom not using the downflow type, the same cleanliness as in the prior art downflow type cleanroom can be achieved in the transportation method, thereby considerably reducing the factory cost and product cost.

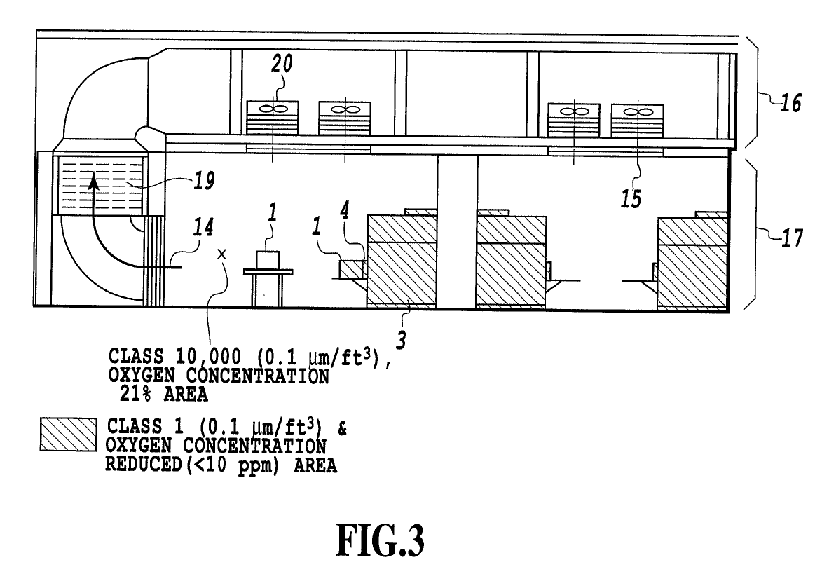

FIG. 3 shows an example in which the transportation method of the present invention is applied in the turbulent type cleanroom. In FIG. 3, numeral 19 denotes a temperature control unit, and 20 is a blowing and cleaning unit. The hatched part is an area maintained in a cleanliness class 1 (0.1 μm/f³) and an oxygen concentration reduced state (<10 ppm).

The floor below the process floor (18 in FIG. 9) is unnecessary, which provides a considerable reduction of the construction cost. Further, as shown in FIG. 3, in the transportation method of the present invention, since it is sufficient to make only the semi-finished product atmosphere to cleanliness class 1 (0.1 μm/f³), and the human working environment may be in much lower cleanliness, power and filter costs, cleaning cost, apparatus cost, and personal education cost are drastically decreased. Still further, by separating the semi-finished product atmosphere environment from the human working environment, reduction of oxygen concentration in the semi-finished environment becomes first possible (hatched area in FIG. 3). This has an innovative meaning for the whole of production technology. The effect of production in the consistent oxygen reduced environment is expected to be applied in all industrial fields in the future.

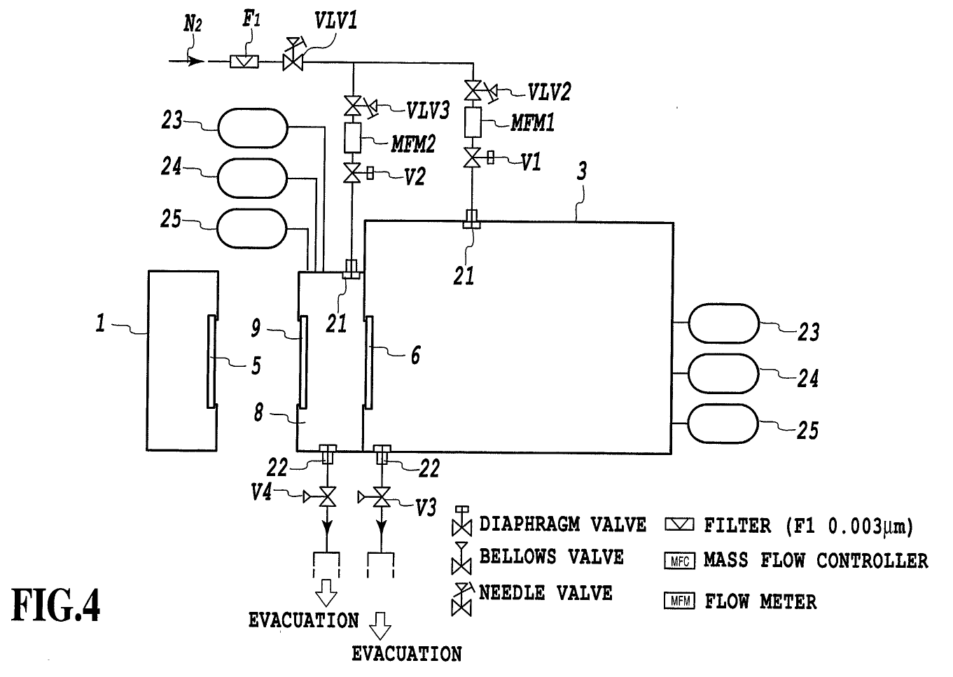

FIG. 4 shows an embodiment of the local clean system provided with air lock means. At a semi-finished product introduction port at a main chamber (processing and treating chamber) 3 corresponding to the processing and treating apparatus, a chamber (air lock chamber) 8 provided with an air lock means is attached. The main chamber 3 and the air lock means are provided respectively with a nitrogen introduction port 21 and an evacuation port 22, an oxygen concentration meter 23, a micro-pressure difference meter 24, and a particle counter 25. Although the evacuation port 22 and the nitrogen introduction port 21 of the main chamber 3 are not necessarily required, they are provided for convenience of experiment of the embodiment. Further, the transportation vessel is a sealed type, and not provided with a filter for pressure control or the like. With this construction, not only particles but also unnecessary gas molecules can be blocked. The sealed vessel 1 for transportation is sealed with a rubber ring from the outside for preventing occurrence of gas leakage with the air lock means. Volumes of the main chamber 3 and the air lock chamber 8 are 108 liters and 5.8 liters, respectively. The present invention can be achieved with such simple apparatus.

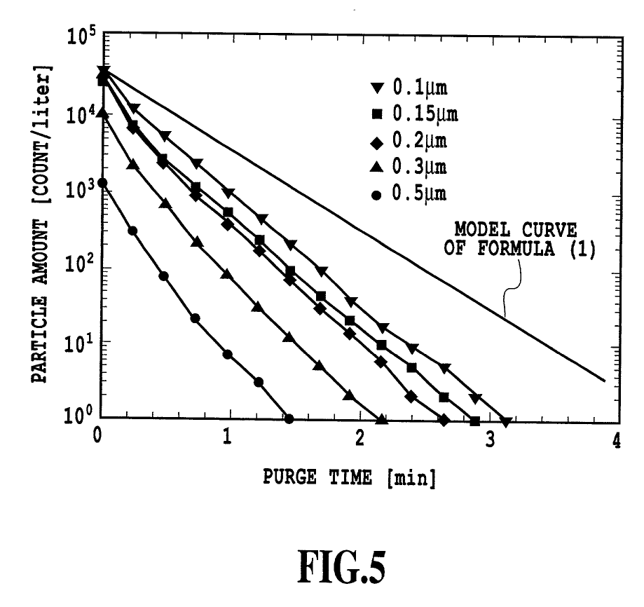

FIG. 5 shows a particle removal effect by the present invention. In FIG. 5, the air lock chamber is opened in an initial state of the cleanliness of the outside of about class 1,000,000 (0.1 μm/f³), a reduction condition of particle count from starting nitrogen purge immediately after closing the air lock chamber shutter is shown. After about 3 minutes from the beginning of nitrogen purge, particle is not counted at all. The state of not counting is continued for over 1 hour of observation. Continuation of uncounting state at 0.1 μm indicates that the cleanliness is much better than class 1 (0.1 μm/ft³). Further, all of observed particle concentrations are decreasing faster than the model curve of formula (1). This shows that perfect mixing of gases does not take place, and gases are discharged faster than that. The gas amount required for purge is about 60 liters. Important matter is that at the point of time when the effect of nitrogen purge saturates, even if the shutter between the main chamber and the air lock chamber is opened, particle is not detected at all in the main chamber, and a very high cleanliness is maintained.

From the above result, it is shown that in the present embodiment, the particle removal rate is more than 10⁶. This shows that since ordinary outside air is cleanliness of about class 1,000,000 (0.1 μm/ft³), even when the cleanroom is not used, in the present environment, a cleanliness of about class 1 (0.1 μm/ft³) can be realized. Further, the present embodiment is carried out in the turbulent type cleanroom of a cleanliness of about class 1,000,000 (0.1 μm/ft³). This demonstrates that in far lower-cost atmosphere than down flow type of the turbulent type, cleanliness of less than class 1 (0.1 μm/ft³) can be simply attained. Still further, with the present invention, in the down flow type of less than class 100 (0.1 μm/ft³), cleanliness of less than class 1 (0.1 μm/ft³) can be achieved in a simpler cleanroom system.

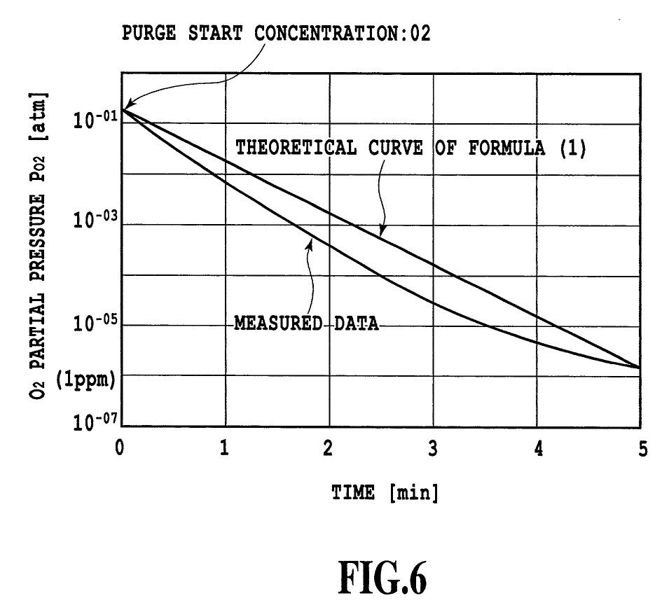

Gas molecule removal effect by the present invention is shown in FIG. 6. In the outside and cleanroom, not only particles but also various gas molecules harmful to the semi-finished product exist. Since, in the air lock system of the present invention, perfect sealing is performed over the entire system, such gas molecules can be controlled. In FIG. 6, a reduction condition of oxygen molecule from starting nitrogen purge immediately after closing the air lock chamber shutter is shown when the air lock chamber is opened in an initial condition of the cleanliness of the outside is about class 1,000,000 (0.1 μm/ft³) same as in FIG. 5. About 5 minutes after starting nitrogen purge, an oxygen concentration reduction of about 5 figures is achieved. Since oxygen molecule concentration is decreased faster than perfect molecule mixing model shown by formula (1), it is found that mixing is not perfect and gas is discharged faster. The reason why in a time of about 5 minutes, the measure data overlaps formula (1) and the measured value saturates is that the performance of the apparatus of the present embodiment has a five figures higher performance in view of leakage. Important matter is that even if the shutter between the main chamber and the air lock chamber is opened at the time when effect of nitrogen purge saturates, in the main chamber, no change is noted from the oxygen concentration of 2 ppm before opening the shutter.

As for moisture, it can be removed same as particles or oxygen molecule. When the air lock chamber is opened in the initial state of a relative humidity of 50% of the outside, and nitrogen purge is started immediately after closing the air lock chamber shutter, water concentration is reduced as well. In the apparatus of the present embodiment, relative humidity can be reduced to 0.35%. This value corresponds to a water partial pressure of about 13 Pa.

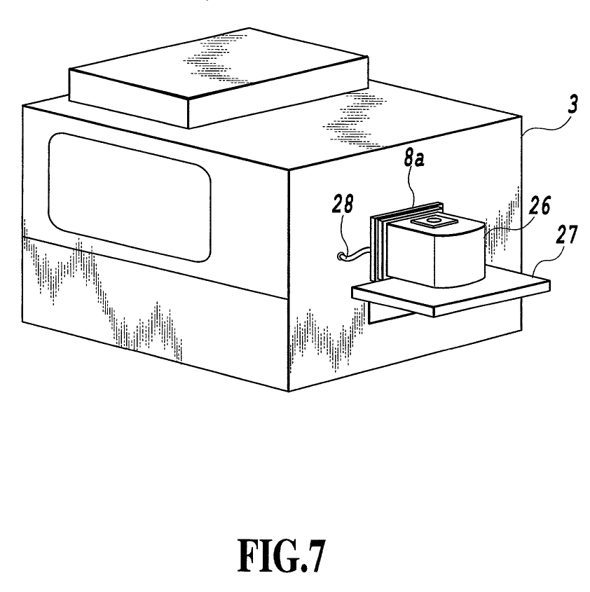

FIG. 7 shows a construction example of the sealed vessel 1 for transporting a semiconductor wafer and the processing and treating apparatus 3. In FIG. 7, numeral 26 denotes a sealed vessel main body, 27 is an introduction table, and 28 is a purge gas introduction pipe. An air lock means 8a is provided at the wafer introduction part of the processing and treating apparatus 3. The air lock means 8a is connected with a purge gas introduction line 28 and an evacuation line (not shown). The sealed vessel 1 for transportation is provided with an introduction table 26 so that the air lock chamber is connected in a state not being applied with its own weight.

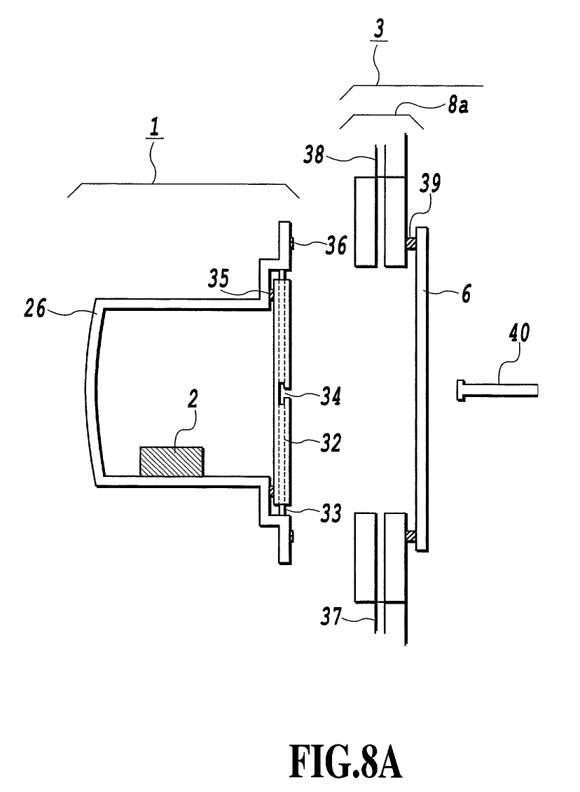

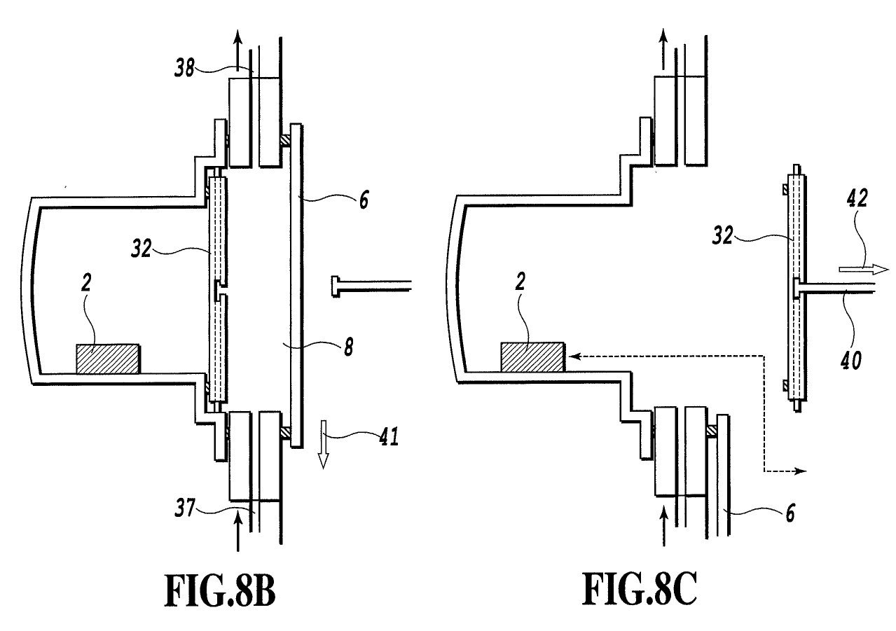

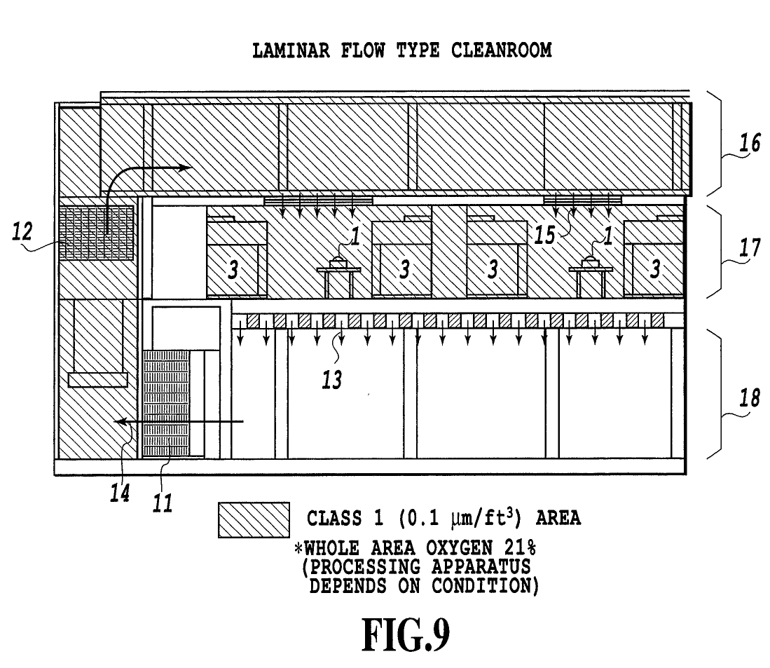

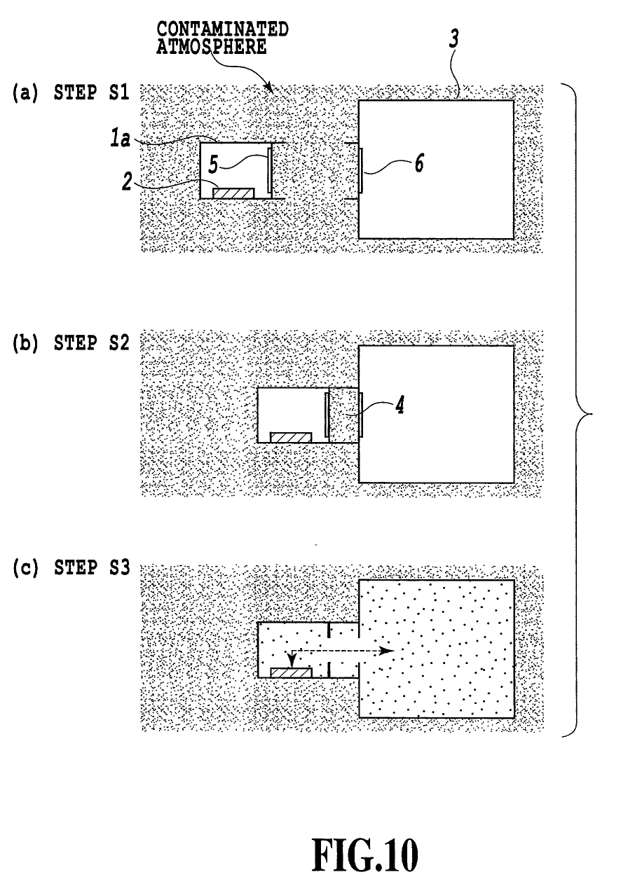

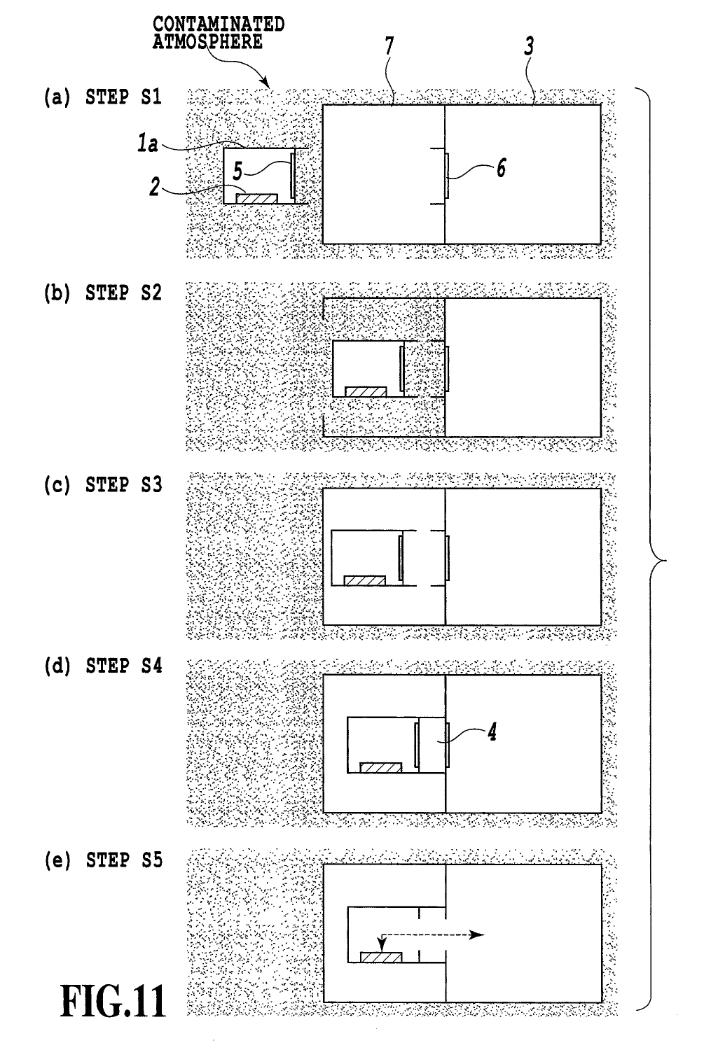

FIG. 8A shows in detail the sealed vessel 1 and the air lock means. In the present embodiment, a connection side shutter 9 (FIG. 1) of the air lock chamber (air lock space) is not provided from the first. In FIG. 8A, numeral 8a denotes an air lock means, 32 is a vessel cover, 33 is a cover holding rod, 34 is a cover opening keyhole, 35 is a vessel seal, 36 is a connection part seal, 37 is a purge gas supply line, 38 is an evacuation line, 39 is a seal, and 40 is a cover opening and pulling rod. The sealed vessel main body 26 is provided with the vessel cover 32 for sealing mounted by the cover holding rod 32. The air lock means 8a is provided at the processing and treating apparatus side but no cover is used for the air lock means for cost down and simplicity of operation.

FIG. 8B shows a state where the sealed vessel 1 is connected to the air lock means 8a. In FIG. 8B, a sealed air lock space (air lock chamber) 8 is formed between the sealed vessel 1 and the processing and treating apparatus 3. This air lock space 8 is exposed to the external air before the sealed vessel 1 is connected to the air lock means 8a, and is thus contaminated. This contaminated atmosphere is removed by gas purge or vacuum evacuation. When vacuum evacuated, by introduction of gas afterward, the atmosphere is immediately reverted to the atmospheric pressure, and external air leakage can be reduced to a negligible level.

In the case of gas purge, particles and oxygen concentration can be reduced by the same principle as in FIG. 5 and FIG. 6. Inside of the air lock space 8 is slightly higher pressure than atmospheric pressure, leakage of particles and oxygen molecule cannot be caused. In the vacuum evacuation method, contaminated atmosphere can be removed in a short time, however, since inside of the air lock space is under vacuum, the apparatus is required to have a structure strong to leakage. By any of the methods, inside of the air lock space can be made to clean atmosphere.

After that, as shown in FIG. 8B, the shutter 6 of the processing and treating apparatus 3 is moved to open to arrow 41 to the lower side of the figure. Next, as shown in FIG. 8C, the vessel cover 32 is removed by moving the cover opening and pulling rod 40 in the direction of arrow 42. Finally, the semi-finished product 2 is taken out from the sealed vessel 1 and, for example, is conducted into the processing and treating apparatus 3 through the route shown by the dotted line in the figure.

The procedure of reverting the wafer 2 from inside the processing and treating apparatus 3 to the sealed vessel 1, is performed by the reverse method to the above. In this case, since insides of the processing and treating apparatus 3, the air lock space 8 and the sealed vessel 1 are respectively maintained in a clean atmosphere, the procedure of purge and vacuum evacuation can be omitted. After containing the semi-finished product in the sealed vessel 1, the vessel cover 32 and the processing and treating apparatus shutter 6 are closed, and the sealed vessel main body 26 is separated to complete the operation.

By providing the air lock means, the semi-finished product 2 requiring higher cleanliness can be transported between the processing and treating apparatus 3 and the sealed vessel 1 without cleaning the outside. Using this procedure, production cost of a product requiring cleanliness in the production stage can be remarkably reduced. Since production of a product requiring cleanliness becomes possible without cleaning the outside, the cleanroom can be omitted. This remarkably reduces installation and maintenance costs of the production equipment. Further, by the substantial space-saving effect of the air lock means, footprint required for the processing and treating apparatus can be reduced.

The present invention has been described in detail with respect to preferred embodiments, and it will now be apparent from the foregoing to those skilled in the art that changes and modifications may be made without departing from the invention in its broader aspect, and it is the intention, therefore, in the apparent claims to cover all such changes and modifications as fall within the true spirit of the invention.

What is claimed is:

1. A local clean method for cleaning atmosphere for processing and treating a semi-finished product using a perfectly sealed semi-finished product transportation apparatus for transporting said semi-finished product during production in cleaned atmosphere and a cleaned processing and treating apparatus, comprising a step of:
removing contaminated atmosphere generated as a result of connecting said perfectly sealed semi-finished product transportation apparatus and said processing and treating apparatus by air lock means having an air lock space disposed between said both apparatus.

2. The local clean method as claimed in claim 1, being applied to a cleanroom.

3. The local clean method as claimed in claim 1, when transporting said semi-finished product having a sealed structure into a processing and treating chamber of said processing and treating apparatus, further comprising steps of:
a step wherein atmosphere in said air lock space is vacuum evacuated or gas purged when said semi-finished product transportation apparatus is connected to said air lock space of said air lock means;
a step wherein cleanliness in said air lock space is made same as in said processing and treating chamber; and
a step wherein, subsequently, said semi-finished product in said semi-finished product transportation apparatus is transported into said processing and treating chamber through said air lock space.

4. The local clean method as claimed in claim 1, when transporting said semi-finished product in said processing and treating apparatus out to said semi-finished product transportation apparatus having a sealed structure, further comprising steps of:
a step wherein atmosphere in said air lock space is vacuum evacuated or gas purged when said semi-finished product transportation apparatus is connected to said air lock space of said air lock means;
a step wherein cleanliness in said air lock space is made same as in said processing and treating chamber; and
a step wherein, subsequently, said semi-finished product in said semi-finished product transportation apparatus is transported out to said processing and treating chamber through said air lock space.

5. A local clean processing and treating apparatus for processing and treating a semi-finished product transported in by a semi-finished product transportation apparatus having a sealed structure in a clean atmosphere comprising:
air lock means having an air lock space disposed between said both apparatus for removing particles and gas molecules of external atmosphere generated as a result of connecting said perfectly sealed semi-finished product transportation apparatus and said processing and treating apparatus.

6. The local clean processing and treating apparatus as claimed in claim 5, wherein said air lock means is provided with a vacuum evacuation or gas purge mechanism.
